(19) United States
(12) Patent Application Publication
(10) Pub. No.: US 2018/0171244 A1
(43) Pub. Date: Jun. 21, 2018

(54) PROCESS FOR IMPROVING GASOLINE QUALITY FROM CRACKED NAPHTHA

(71) Applicant: ExxonMobil Research and Engineering Company, Annandale, NJ (US)

(72) Inventor: Mohsen N. Harandi, New Hope, PA (US)

(21) Appl. No.: 15/825,190

(22) Filed: Nov. 29, 2017

Related U.S. Application Data
(60) Provisional application No. 62/434,450, filed on Dec. 15, 2016.

(51) Int. Cl. C10G 65/14; C10G 7/02; C10G 45/12; B01D 3/14

(52) U.S. Cl. CPC C10G 65/14; C10G 7/02; C10G 45/12; C10G 2400/02; C10G 2300/202; C10G 2300/104; C10G 2300/1044; B01D 3/14

(57) ABSTRACT

A method is provided for producing gasoline that includes separating a cracked naphtha feed into a light catalytic naphtha fraction and a heavy naphtha fraction; and exposing the light catalytic naphtha fraction to a catalyst under effective conversion conditions to reduce sulfur content of the light catalytic naphtha fraction while also reducing a Reid vapor pressure and an olefin content of the light catalytic naphtha fraction, wherein the effective conversion conditions comprise a pressure of less than about 500 psig and a temperature of at least about 550° F. (288° C.).

### CROSS-REFERENCE TO RELATED APPLICATIONS

This application claims priority to U.S. Provisional Application Ser. No. 62/434,450 filed Dec. 15, 2016, which is herein incorporated by reference in its entirety.

### FIELD

This application relates to the field of gasoline production.

### BACKGROUND

Light catalytic naphta (LCN) has been a challenging component for economic gasoline blending and emissions control. Generally, LCN is relatively high in Reid vapor pressure (RVP), relatively low in octane, and contains most of the gasoline pool's sulfur and olefin content. Hydroprocessing of LCN is a common way to address the sulfur content of the component; however, hydroprocessing may not improve RVP and saturates at least some of the olefin content, adversely impacting octane.

It would be desirable to provide other ways to address sulfur content of LCN while improving the quality of LCN or otherwise improving the process.

### SUMMARY

In one aspect, a method is provided for producing gasoline. The method includes separating a cracked naphtha feed into a light catalytic naphtha fraction and a heavy naphtha fraction; and exposing the light catalytic naphtha fraction to a catalyst under effective conversion conditions to reduce sulfur content of the light catalytic naphtha fraction while also reducing a Reid vapor pressure and an olefin content of the light catalytic naphtha fraction, wherein the effective conversion conditions comprise a pressure of less than about 500 psig and a temperature of at least about 550° F. (288° C.).

In another aspect, a gasoline pool for a refinery is provided. The gasoline pool includes one or more grades of gasoline product produced by the refinery, each of the one or more grades of gasoline product comprising gasoline boiling range hydrocarbons, and wherein a total olefin content for the gasoline pool in a month is about 3.0 vol % or less.

### DRAWINGS

FIG. 1 is a schematic illustrating an exemplary process of producing gasoline according to one or more embodiments of the present invention.

### DETAILED DESCRIPTION

It has been found that sulfur reduction of a cracked naphtha feed may be achieved while providing other improvements in the qualities of the gasoline product, such as olefin reduction and/or octane improvement, by separating the cracked naphtha feed into a light catalytic naphtha fraction and heavy naphtha fraction and then exposing the light catalytic naphtha fraction to a catalyst under effective conditions for reducing the sulfur content and at least one of the Reid vapor pressure or olefin content of the fraction.

As used herein, and unless specified otherwise, “gasoline” or “gasoline boiling range hydrocarbons” refers to a composition containing at least predominantly C5-C12 hydrocarbons. In one embodiment, gasoline or gasoline boiling range components is further defined to refer to a composition containing at least predominantly C5-C12 hydrocarbons and further having a boiling range of from about 100° F. to about 450° F. In an alternative embodiment, gasoline or gasoline boiling range components is defined to refer to a composition containing at least predominantly C5-C12 hydrocarbons, having a boiling range of from about 100° F. to about 450° F., and further defined to meet ASTM standard D439.

The term “gasoline pool” as used herein refers to the total of all gasoline boiling range hydrocarbons produced by a refinery that are ultimately sold as gasoline product. As such, the term “gasoline pool” does not include gasoline boiling range hydrocarbons that are present in other products produced by the refinery, such as other fuel products (e.g., jet fuel). The gasoline pool may refer to the amount of product produced over a specific period of time, e.g., weekly, monthly, yearly, etc.

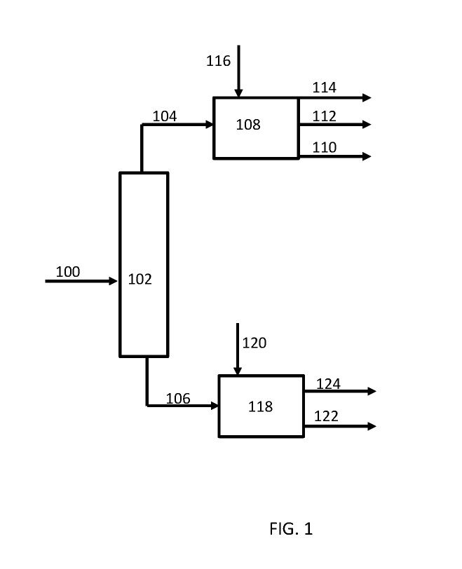

An illustrative embodiment is illustrated in FIG. 1. Cracked naphtha feed 100 may be fed to a separator 102 to separate the cracked naphtha feed 100 into a light catalytic naphtha fraction 104 and a heavy naphtha fraction 106. The light catalytic naphtha fraction 104 may generally include a predominate portion of the C5 hydrocarbons present in the cracked naphtha feed 100 as well as a predominate portion of the C6 and C7 hydrocarbons present in the cracked naphtha feed 100. The heavy naphtha fraction 106 may include at least 90 wt % of the C9 and heavier (C9+) hydrocarbons present in the cracked naphtha feed 100.

The light catalytic naphtha fraction 104 may be fed to a reactor 108 where it is exposed to a conversion catalyst under effective conditions to reduce the sulfur content of the light catalytic naphtha fraction 104 and at least one of the olefin content of the fraction 104 or the Reid vapor pressure of the fraction 104. For example, the catalyst may be a silicoaluminophosphate (SAPO) or a zeolite catalyst, such as a ZSM-5 catalyst. The conversion conditions may further include a pressure of less than about 500 psig and a temperature of at least about 550° F., such as a temperature of between about 700° F. and about 900° F. or between about 750° F. and about 850° F. The resulting low sulfur light catalytic naphtha product 110 may then be blended into a final gasoline product. An olefinic liquid propane gas product 112 and a C2− hydrocarbon product may also be recovered from the effluent of reactor 108. Optionally, an olefinic fuel gas or light olefin feed 116 may be cofed to reactor 108 to further enhance the resulting products.

The heavy naphtha fraction 106 may be selectively hydrotreated in reactor 118. For example, reactor 118 may be a SCANfining reactor to produce low sulfur containing naphtha.

### Cracked Naphtha Feed

Various naphtha boiling range feeds may be employed in the processes and systems disclosed herein. Advantageously, the disclosed processes and systems may be employed with cracked naphtha feeds, such as fluid catalytic cracking (FCC) naphtha, coker naphtha, and/or steam cracker naphtha.

For example, the disclosed systems and processes may be employed with hydrocarbon feeds boiling between about 100° F. and about 450° F.

### Separating Cracked Naphtha

Before further treatment, the cracked naphtha feed may be separated into a light catalytic naphtha fraction and a heavy naphtha fraction. The temperature and pressure at which the separation is performed may vary depending on the composition of the cracked naphtha feed. For example, the separation may be performed at a bottom temperature between 300-550 F and a pressure between 0-150 Psig.

In particular, separation may be performed under conditions such that the light catalytic naphtha fraction comprises C5-C7 hydrocarbons present in the cracked naphtha feed. For example, the light catalytic naphtha fraction may contain at least 50 wt %, or at least 60 wt %, or at least 70 wt %, or at least 90 wt %, or at least 95 wt %, or at least 99 wt % of the C5 hydrocarbons present in the cracked naphtha feed. In addition, the light catalytic naphtha fraction may contain at least 50 wt %, or at least 60 wt %, or at least 70 wt %, or at least 90 wt %, or at least 95 wt %, or at least 99 wt % of the C6 hydrocarbons present in the cracked naphtha feed. Further, the light catalytic naphtha fraction may contain at least 50 wt %, or at least 60 wt %, or at least 70 wt %, or at least 90 wt %, or at least 95 wt %, or at least 99 wt % of the C7 hydrocarbons present in the cracked naphtha feed.

### Conversion of LCN

After separation of the light catalytic naphtha (“LCN”) fraction, the LCN fraction may be exposed to a conversion catalyst under effective conditions to reduce the sulfur content of the LCN fraction as well as the olefin content and the Reid vapor pressure of the fraction.

In various aspects, the LCN can be exposed to an acidic catalyst (such as a zeolite) under effective conversion conditions for olefinic oligomerization and/or sulfur removal. Optionally, the zeolite or other acidic catalyst can also include a hydrogenation functionality, such as a Group VIII metal or other suitable metal that can activate hydrogenation/dehydrogenation reactions. The LCN can be exposed to the acidic catalyst preferably without providing any additional hydrogen to the reaction environment. Added hydrogen refers to hydrogen introduced as an input flow to the process, as opposed to any hydrogen that might be generated in-situ during processing. Exposing the LCN to an acidic catalyst with providing added hydrogen is acceptable. The acidic catalyst used in the processes described herein can be a zeolite-based catalyst, that is, it can comprise an acidic zeolite in combination with a binder or matrix material such as alumina, silica, or silica-alumina, and optionally further in combination with a hydrogenation metal. More generally, the acidic catalyst can correspond to a molecular sieve (such as a zeolite) in combination with a binder, and optionally a hydrogenation metal. Molecular sieves for use in the catalysts can be medium pore size zeolites, such as those having the framework structure of ZSM-5, ZSM-11, ZSM-12, ZSM-22, ZSM-23, ZSM-35, ZSM-48, or MCM-22. Such molecular sieves can have a 10-member ring as the largest ring size in the framework structure. The medium pore size zeolites are a well-recognized class of zeolites and can be characterized as having a Constraint Index of 1 to 12. Constraint Index is determined as described in U.S. Pat. No. 4,016,218 incorporated herein by reference. Catalysts of this type are described in U.S. Pat. Nos. 4,827,069 and 4,992,067 which are incorporated herein by reference and to which reference is made for further details of such catalysts, zeolites and binder or matrix materials.

Additionally or alternately, catalysts based on large pore size framework structures (12-member rings) such as the synthetic faujasites, especially zeolite Y, such as in the form of zeolite USY. Zeolite beta may also be used as the zeolite component. Other materials of acidic functionality which may be used in the catalyst include the materials identified as MCM-36 and MCM-49. Still other materials can include other types of molecular sieves having suitable framework structures, such as silicoaluminophosphates (SAPOs), aluminosilicates having other heteroatoms in the framework structure, such as Ga, Sn, or Zn, or silicoaluminophosphates having other heteroatoms in the framework structure. Mordenite or other solid acid catalysts can also be used as the catalyst.

In various aspects, the exposure of the LCN fraction to the acidic catalyst can be performed in any convenient manner, such as exposing the LCN fraction to the acidic catalyst under fluidized bed conditions, moving bed conditions, and/or in a riser reactor. In some aspects, the particle size of the catalyst can be selected in accordance with the fluidization regime which is used in the process. Particle size distribution can be important for maintaining turbulent fluid bed conditions as described in U.S. Pat. No. 4,827,069 and incorporated herein by reference. Suitable particle sizes and distributions for operation of dense fluid bed and transport bed reaction zones are described in U.S. Pat. Nos. 4,827,069 and 4,992,607 both incorporated herein by reference. Particle sizes in both cases will normally be in the range of 10 to 300 microns, typically from 20 to 100 microns.

Acidic zeolite catalysts suitable for use as described herein can be those exhibiting high hydrogen transfer activity and having a zeolite structure of ZSM-5, ZSM-11, ZSM-12, ZSM-22, ZSM-23, ZSM-35, ZSM-48, MCM-22, MCM-36, MCM-49, zeolite Y, and zeolite beta. Such catalysts can be capable of oligomerizing olefins from the olefin-containing feed. For example, such catalysts can convert C5-C7 olefins, such as those present in cracked naphtha feed, to higher olefins or to saturated hydrocarbons. Such catalysts can also be capable of converting organic sulfur compounds such as mercaptans to hydrogen sulfide without added hydrogen by utilizing hydrogen present in the hydrocarbon feed. Group VIII metals such as nickel may be used as desulfurization promoters. A fluid-bed reactor/regenerator can assist with maintaining catalyst activity in comparison with a fixed-bed system. Further, the hydrogen sulfide produced in accordance with the processes described herein can be removed using conventional amine based absorption processes.

ZSM-5 crystalline structure is readily recognized by its X-ray diffraction pattern, which is described in U.S. Pat. No. 3,702,866. ZSM-11 is disclosed in U.S. Pat. No. 3,709,979, ZSM-12 is disclosed in U.S. Pat. No. 3,832,449, ZSM-22 is disclosed in U.S. Pat. No. 4,810,357, ZSM-23 is disclosed in U.S. Pat. Nos. 4,076,842 and 4,104,151, ZSM-35 is disclosed in U.S. Pat. No. 4,016,245, ZSM-48 is disclosed in U.S. Pat. No. 4,375,573 and MCM-22 is disclosed in U.S. Pat. No. 4,954,325. The U.S. Patents identified in this paragraph are incorporated herein by reference.

While suitable zeolites having a coordinated metal oxide to silica molar ratio of 20:1 to 200:1 or higher may be used, it can be advantageous to employ aluminosilicate ZSM-5 having a silica:alumina molar ratio of about 25:1 to 70:1, suitably modified. A typical zeolite catalyst component having Bronsted acid sites can comprises, consist essentially of, or consist of crystalline aluminosilicate having the structure of ZSM-5 zeolite with 5 to 95 wt. % silica, clay and/or alumina binder.

These siliceous zeolites can be employed in their acid forms, ion-exchanged or impregnated with one or more suitable metals, such as Ga, Pd, Zn, Ni, Co, Mo, P, and/or other metals of Periodic Groups III to VIII. The zeolite may include other components, generally one or more metals of group IB, IIB, IIIB, VA, VIA or VIIIA of the Periodic Table (IUPAC).

Useful hydrogenation components can include the noble metals of Group VIIIA, such as platinum, but other noble metals, such as palladium, gold, silver, rhenium or rhodium, may also be used. Base metal hydrogenation components may also be used, such as nickel, cobalt, molybdenum, tungsten, copper or zinc.

The catalyst materials may include two or more catalytic components which components may be present in admixture or combined in a unitary multifunctional solid particle.

In addition to the preferred aluminosilicates, the gallosilicate, ferrosilicate and “silicalite” materials may be employed. ZSM-5 zeolites can be useful in the process because of their regenerability, long life and stability under the extreme conditions of operation. Usually the zeolite crystals have a crystal size from about 0.01 to over 2 microns or more, such as 0.02-1 micron.

In various aspects, the catalyst particles can contain about 25 wt. % to about 40 wt. % H-ZSM-5 zeolite, based on total catalyst weight, contained within a silica-alumina matrix. Typical Alpha values for the catalyst can be about 100 or less. Sulfur conversion to hydrogen sulfide can increase as the alpha value increases.

The Alpha Test is described in U.S. Pat. No. 3,354,078, and in the Journal of Catalysis, Vol. 4, p. 527 (1965); Vol. 6, p. 278 (1966); and Vol. 61, p. 395 (1980), each incorporated herein by reference as to that description.

In various aspects, the LCN fraction may be exposed to the acidic catalyst by using a moving or fluid catalyst bed reactor. In such aspects, the catalyst may be regenerated, such via continuous oxidative regeneration. The extent of coke loading on the catalyst can then be continuously controlled by varying the severity and/or the frequency of regeneration. In a turbulent fluidized catalyst bed the conversion reactions are conducted in a vertical reactor column by passing hot reactant vapor upwardly through the reaction zone and/or reaction vessel at a velocity greater than dense bed transition velocity and less than transport velocity for the average catalyst particle. A continuous process is operated by withdrawing a portion of coked catalyst from the reaction zone and/or reaction vessel, oxidatively regenerating the withdrawn catalyst and returning regenerated catalyst to the reaction zone at a rate to control catalyst activity and reaction severity to affect feedstock conversion. Preferred fluid bed reactor systems are described in Avidan et al U.S. Pat. No. 4,547,616; Harandi & Owen U.S. Pat. No. 4,751,338; and in Tabak et al U.S. Pat. No. 4,579,999, incorporated herein by reference. In other aspects, other types of reactors can be used, such as fixed bed reactors, riser reactors, fluid bed reactors, and/or moving bed reactors.

In one or more aspects, effective conversion conditions for exposing the olefin-containing feed to an acidic catalyst can include a temperature of about 300° F. (149° C.) to about 900° F. (482° C.), or about 350° F. (177° C.) to about 850° F. (454° C.), or about 350° F. (177° C.) to about 800° F. (427° C.), or about 350° F. (177° C.) to about 750° F. (399° C.), or about 350° F. (177° C.) to about 700° F. (371° C.), or a temperature of at least about 400° F. (204° C.), or at least about 500° F. (260° C.), or at least about 550° F. (288° C.), or at least about 600° F. (316° C.); a pressure of about 50 psig (0.34 MPag) to about 1100 psig (7.6 MPag), or a pressure of about 100 psig (0.69 MPag) to about 1000 psig (6.9 MPag), or a pressure of about 100 psig (0.69 MPag) to about 200 psig (1.4 MPag), or about 150 psig (1.0 MPag) to about 975 psig (6.7 MPag), or about 200 psig (1.4 MPag) to about 950 psig (6.6 MPag), or about 250 psig (1.7 MPag) to about 900 psig (6.2 MPag), or about 300 psig (4.1 MPag) to about 850 psig (5.9 MPag), or about 300 psig (4.1 MPag) to about 800 psig (5.5 MPag), or a pressure of at least about 50 psig (0.34 MPag), or a pressure of at least about 100 psig (0.69 MPag), or a pressure of at least about 150 psig (1.0 MPag), or a pressure of at least about 200 psig (1.4 MPag), or a pressure of at least about 250 psig (1.7 MPag), or a pressure of at least about 300 psig (4.1 MPag), or a pressure of at least about 350 psig (2.4 MPag); and a total feed WHSV of about 0.05 hr-1 to about 40 hr-1, or about 0.05 to about 30 hr-1, or about 0.1 to about 20 hr-1, or about 0.1 to about 10 hr-1. Optionally, the total feed WHSV can be about 1 hr-1 to about 40 hr-1 to improve C5+ yield.

In addition to a total feed WHSV, a WHSV can also be specified for just the olefin compounds in the feed. In other words, an olefin WHSV represents a space velocity defined by just the weight of olefins in a feed relative to the weight of catalyst. In one or more aspects, the effective conversion conditions can include an olefin WHSV of at least about 0.8 hr-1, or at least about 1.0 hr-1, or at least about 2.0 hr-1, or at least about 3.0 hr-1, or at least about 4.0 hr-1, or at least about 5.0 hr-1, or at least about 8.0 hr-1, or at least about 10 hr-1, or at least about 15 hr-1. In the same or alternative aspects, the effective conversion conditions can include an olefin WHSV of about 40 hr-1 or less, or about 30 hr-1 or less, or about 20 hr-1 or less. In certain aspects, the effective conversion conditions can include an olefin WHSV of about 0.8 hr-1 to about 30 hr-1, or about 0.8 hr-1 to about 20 hr-1, or about 0.8 hr-1 to about 15 hr-1, or about 0.8 hr-1 to about 10 hr-1, or about 0.8 hr-1 to about 7 hr-1, or about 0.8 hr-1 to about 5 hr-1, or about 1.0 hr-1 to about 30 hr-1, or about 1.0 hr-1 to about 20 hr-1, or about 1.0 hr-1 to about 15 hr-1, or about 1.0 hr-1 to about 10 hr-1, or about 1.0 hr-1 to about 7 hr-1, or about 1.0 hr-1 to about 5 hr-1, or about 2.0 hr-1 to about 30 hr-1, or about 2.0 hr-1 to about 20 hr-1, or about 2.0 hr-1 to about 15 hr-1, or about 2.0 hr-1 to about 10 hr-1, or about 2.0 hr-1 to about 7 hr-1, or about 2.0 hr-1 to about 5 hr-1, about 4.0 hr-1 to about 30 hr-1, or about 4.0 hr-1 to about 20 hr-1, or about 4.0 hr-1 to about 15 hr-1, or about 4.0 hr-1 to about 10 hr-1, or about 4.0 hr-1 to about 7 hr-1. An olefin WHSV of about 1 hr-1 to about 40 hr-1 can be beneficial for increasing the C5+ yield.

In various aspects, decreasing the temperature when the olefin WHSV is increased, e.g., when the olefin WHSV is increased above 1 hr-1, may improve product yield. For example, in such aspects, temperatures of about 600° F. (316° C.) to about 800° F. (427° C.), or about 650° F. (343° C.) to about 750° F. (399° C.) may aid in increasing product yield, such as the yield of C5+ compounds, when the olefin WHSV is increased above 1 hr-1.

Selective Hydrotreatment of Heavy Naphtha

The heavy naphtha fraction may be hydrotreated, such as by conventional fixed bed hydrotreating, or the heavy naphtha fraction can be selectively hydrotreated, such as for example using a SCANfining process.

Hydrodesulfurization (HDS) processes are well known in the art. During such processes, an additional reaction occurs whereby the hydrogen sulfide produced during the process reacts with feed olefins to form alkylmercaptans. This reaction is commonly referred to as mercaptan reversion. Thus, to prevent such mercaptan reversion as well as to significantly convert sulfur in the feed requires saturation of feed olefins resulting in a loss of octane.

It has been discovered, that the amount of mercaptan reversion sulfur compounds in the reactor is controlled by the equilibrium established by the reactor exit temperature, exit olefin and H2S partial pressure, and that the SCANfining process can be run to produce an amount of mercaptan reversion sulfur in the reactor that is often higher than the desired specification amount while removing non-mercaptan sulfur to an acceptable regulatory level. Thus, by running the SCANfiner, or other selective hydrodesulfurization process in such a manner, and combining it with a second step to remove the undesirable mercaptan reversion sulfur compounds produced, regulatory sulfur levels can be met while retaining octane in the product produced.

Hence, the product of the HDS unit, which will have a mercaptan reversion sulfur content well above the desired specification but an acceptable non-mercaptan sulfur level (pre-determined), will be sent to a mercaptan removal step where at least a portion of the mercaptan reversion sulfur compounds will be selectively removed, thereby, producing a product that meets specification. By at least a portion, it is meant that at least about 30 wt %, preferably at least about 50 wt %, based on the petroleum feedstream. More preferably, at least that amount of meraptan reversion sulfur compounds is removed so that the naphtha produced by the present process meets environmental regulatory standards.

For example, a heavy catalytic naphtha fraction can be hydroprocessed to 60 wppm total sulfur where approximately 45 wppm sulfur is mercaptan reversion sulfur. This first product would not meet the future 30 wppm sulfur specification. This product would then be sent to a removal step wherein at least a portion of the mercaptan reversion sulfur compounds would be removed to reduce the sulfur level of the first product to approximately 20 wppm total sulfur, meeting the specification. By hydroprocessing the sample only to 60 wppm total sulfur, olefin saturation will be less than is obtained from hydroprocessing to 20 wppm directly. Thus, considerable octane is preserved affording an economical and regulatory acceptable product.

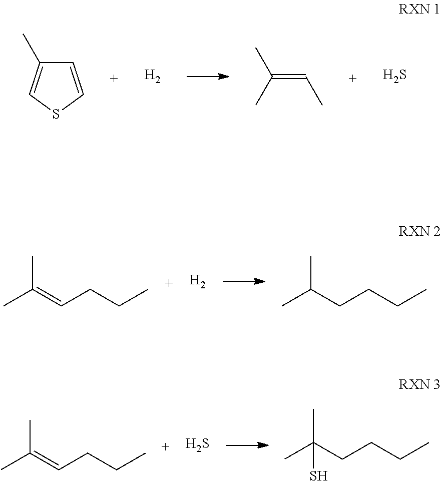

In the hydroprocessing reactor, heavy naptha fraction and hydrogen may be passed over a hydroprocessing catalyst where organic sulfur is converted to hydrogen sulfide (Rxn 1) and olefins are saturated to their corresponding paraffins (Rxn 2). In a typical catalytic naphtha feed, organic sulfur species such as, for example, thiophenes, benzothiophenes, mercaptans, sulfides, disulfides and tetrahydrothiophenes are present. Typically greater than 95% of these organic sulfur species are in the form of thiophenic-type structures. When HDS is conducted at conditions described above to retain olefins, hydrogen sulfide from thiophene HDS reacts with feed olefins to form mercaptan reversion sulfur compounds (Rxn 3), referred to as mercaptan reversion herein. Mercaptan reversion (Rxn 3) occurs irrespective of whether or not the feed being desulfurized contains mercaptans. Thus, the sulfur compounds formed by mercaptan reversion are referred to as mercaptan reversion sulfur compounds.

The hydrodesulfurization conditions needed to produce a hydrotreated naphtha stream which contains non-mercaptan sulfur at a level below the mogas specification as well as significant amounts of mercaptan reversion sulfur compounds will vary as a function of the concentration of sulfur and types of organic sulfur in the cracked naphtha feed to the HDS unit. Generally, the processing conditions will fall within the following ranges: 475-600° F. (246-316° C.), 150-500 psig (1136-3548 kPa) total pressure, 100-300 psig (791-2170 kPa) hydrogen partial pressure, 1000-2500 SCF/B hydrogen treat gas, and 1-10 LHSV.

Any hydrodesulfurization technology known to those skilled in the art that is capable of converting greater than 95% of the thiophenic sulfur in the feed can be used herein. However, the preferred hydroprocessing step to be utilized is SCANfining. It should also be noted that other selective cat naphtha hydrodesulfurization processes such as those taught by Mitsubishi (See U.S. Pat. Nos. 5,853,570 and 5,906,730 herein incorporated by reference) can likewise be utilized herein. SCANFINING is described in National Petroleum Refiners Association paper # AM-99-31 titled “Selective Cat Naphtha Hydrofining with Minimal Octane Loss” and U.S. Pat. Nos. 5,985,136 and 6,013,598 herein incorporated by reference. Selective cat naphtha HDS is also described in U.S. Pat. Nos. 4,243,519 and 4,131,537.

Typical SCANfining conditions include one and two stage processes for hydrodesulfurizing a naphtha feedstock comprising reacting said feedstock in a first reaction stage under hydrodesulfurization conditions in contact with a catalyst comprised of about 1 to 10 wt. % MoO3; and about 0.1 to 5 wt. % CoO; and a Co/Mo atomic ratio of about 0.1 to 1.0; and a median pore diameter of about 60 [Angstrom] to 200 [Angstrom]; and a MoO3 surface concentration in g MoO3/m2 of about 0.5×10−4 to 3×10−4; and an average particle size diameter of less than about 2.0 mm; and, optionally, passing the reaction product of the first stage to a second stage, also operated under hydrodesulfurization conditions, and in contact with a catalyst comprised of at least one Group VIII metal selected from the group consisting of Co and Ni, and at least one Group VI metal selected from the group consisting of Mo and W, more preferably Mo, on an inorganic oxide support material such as alumina.

In one possible flow plan for the invention, the SCANFINING reactor is run at sufficient conditions such that the difference between the total organic sulfur (determined by x-ray adsorption) and the mercaptan reversion sulfur (determined by potentiometric test ASTM3227) of the liquid product from the strippers is at or below the desired (target) specification. This stream is then sent to a second step for removal of mercaptan reversion sulfur compounds.

In the step used to remove mercaptan reversion sulfur compounds, any technology known to the skilled artisan capable of removing ≥C5+ mercaptan reversion sulfur compounds can be employed. For example, sweetening followed by fractionation, thermal decomposition, extraction, adsorption and membrane separation. Other techniques which selectively remove C5+ mercaptan reversion sulfur compounds of the type produced in the first step may likewise be utilized.

One possible method of removing or converting the mercaptan reversion sulfur compounds in accordance with step (b) of the instant process can be accomplished by sweetening followed by fractionation. Sweetening processes are known in the art and are described, for example, in U.S. Pat. No. 5,961,819. Such sweetening processes relating to the treatment of sour distillate hydrocarbons are described in many patents. For instance, U.S. Pat. Nos. 3,758,404; 3,977,829 and 3,992,156 which describe mass transfer apparatus and processes involving the use of fiber bundles which are particularly suitable for such processes.

Other methods for accomplishing oxidation (sweetening) of the mercaptan reversion sulfur compounds followed by fractionation are known and well-established in the petroleum refining industry. Among the oxidation processes which may be used to remove mercaptan reversion sulfur compounds are the copper chloride oxidation process, Mercapfining, chelate sweetening and Merox, of which the Merox process is preferred because it may be readily integrated with an extraction step in the final processing step for the back end.

In the Merox oxidation process, mercaptan reversion compounds are extracted from the feed and then oxidized by air in the caustic phase in the presence of the Merox catalyst, an iron group chelate (cobalt phthalocyanine) to form disulfides which are then redissolved in the hydrocarbon phase, leaving the process as disulfides in the hydrocarbon product. In the copper chloride sweetening process, mercaptan reversion sulfur compounds are removed by oxidation with cupric chloride which is regenerated with air which is introduced with the feed to oxidation step.

Whatever the oxidation process at this stage of the process, the mercaptan reversion compounds are converted to higher boiling disulfides which are transferred to the higher boiling fraction and subjected to hydrogenative removal together with the thiophene and other forms of sulfur present in the higher boiling portion of the cracked feed.

Oxidation processes for mercaptan reversion compounds are described in Modern Petroleum Technology, G. D. Hobson (Ed.), Applied Science Publishers Ltd., 1973, ISBN 085334 487 6, as well as in Petroleum Processing Handbook, Bland and Davidson (Ed.), McGraw-Hill, New York 1967, pages 3-125 to 3-130. The Merox process is described in Oil and Gas Journal 63, No. 1, pp. 90-93 (January 1965). Reference is made to these works for a description of these processes which may be used for converting the lower boiling sulfur components of the front end to higher boiling materials in the back end of the cracked feed.

Another method of removing the mercaptan reversion sulfur compounds in accordance with step (b) will employ a caustic mercaptan extraction step. In the instant invention, a combination of aqueous base and a phase transfer catalyst (PTC) known in the art will be utilized as the extractant or a sufficiently basic PTC.

The addition of a phase-transfer catalyst allows for the extraction of higher molecular weight mercaptan reversion compounds (≥C5+) produced during HDS into the aqueous caustic at a rapid rate. The aqueous phase can then be separated from the petroleum stream by known techniques. Likewise, lower molecular weight mercaptans reversion sulfur compounds, if present, are also removed during the process.

The phase transfer catalysts which can be utilized in the instant invention can be supported or unsupported. The attachment of the PTC to a solid substrate facilitates its separation and recovery and reduces the likelihood of contamination of the product petroleum stream with PTC. Typical materials used to support PTC are polymers, silicas, aluminas and carbonaceous supports.

The PTC and aqueous base extractant may be supported on or contained within the pores of a solid state material to accomplish the extraction of the mercaptan reversion sulfur compounds. After saturation of the supported PTC bed with mercaptide in the substantial absence of oxygen, the bed can be regenerated by flushing with air and a stripper solvent to wash away the disulfide which would be generated. If necessary, the bed could be re-activated with fresh base/PTC before being brought back on stream. This swing bed type of operation may be advantageous relative to liquid-liquid extractions in that the liquid-liquid separation steps would be replaced with solid-liquid separations typical of solid adsorbent bed technologies. Note, the substantial absence of oxygen is required if seeking to remove mercaptan reversion compounds as opposed to sweetening the HDS product to disulfides. By substantial absence is meant no more than that amount of oxygen which will be present in a refinery process despite precautions to exclude the presence of oxygen. Typically, 10 ppm or less, preferably 2 ppm or less oxygen will be the maximum amount present. Preferably, the process will be run in the absence of oxygen.

Such extractions include liquid-liquid extraction where aqueous base and water soluble PTC are utilized to accomplish the extraction, or basic aqueous PTC is utilized. A liquid-liquid extraction with aqueous base and supported PTC where the PTC is present on the surface or within the pores of the support, for example a polymeric support; and liquid-solid extraction where both the basic aqueous PTC or aqueous base and PTC are held within the pores of the support.

Thus, an “extractive” process whereby the thiols are first extracted from the petroleum feedstream in the substantial absence of air into an aqueous phase and the mercaptan reversion sulfur compound-free petroleum feedstream is then separated from the aqueous phase and passed along for further refinery processing can be conducted. The aqueous phase may then subjected to aerial oxidation to form disulfides from the extracted mercaptan reversion sulfur compounds. Separation and disposal of the disulfide would allow for recycle of the aqueous extractant. Regeneration of the spent caustic can occur using either steam stripping as described in The Oil and Gas Journal, Sep. 9, 1948, pp 95-103 or oxidation followed by extraction into a hydrocarbon stream. Such extractants are easily selected by the skilled artisan and can include for example a reformate stream.

If it is desired to conduct a sweetening process, the extraction step can be conducted in air, the loss of thiol is concurrent with generation of disulfide. This indicates a “sweetening process”, in that the total sulfur remains essentially constant in the feedstream, but the mercaptan sulfur is converted to disulfide. Furthermore, the thiol is transported from the organic phase into the aqueous phase, prior to conversion to disulfide then back into the petroleum phase. We have found this oxidation of mercaptides to disulfides to occur readily at room temperature without the addition of any other oxidation catalyst. When conducting a sweetening process, the extracting medium will consist essentially of aqueous base and PTC or aqueous basic PTC.

When utilizing a supported PTC, the porous supports may be selected from, molecular sieves, polymeric beads, carbonaceous solids and inorganic oxides for example.

### Example

It is projected that Reid vapor pressure reduction of 1-2 psi and a road octane improvement of 3 may be achieved by the treatment of a light catalytic naphtha as described herein. By applying this technology to a refinery, a substantial reduction in olefin content in the gasoline pool may be achieved. A representative refinery gasoline pool, having gasoline pool sulfur content of 10 wppm, is reflected in Table 1.

TABLE 1

| | Base case, | W/LCN treat, | Base case, | w/LCN treat, |
|---|---|---|---|---|
| | summer | summer | Winter | winter |
| Grade A, vol % | 10.7 | 3.9 | 4.0 | 0.3 |
| olefins | | | | |
| Grade B, vol % | 3.7 | 2.6 | 5.0 | 2.0 |
| olefins | | | | |
| Grade C, vol % | 14.4 | 3.8 | 13.1 | 2.0 |
| olefins | | | | |
| TOTAL POOL | 6.2 | 3.0 | 5.8 | 1.8 |

As illustrated in Table 1, the refinery making three gasoline products (Grade A-C) typically produces a gasoline pool with a total olefin content of 6.2 vol % in the summer and 5.8 vol % in the winter. However, by separating a light catalytic naphtha fraction from the cracked naphtha feed and subjecting that light catalytic naphtha fraction to treatment under conditions suitable for reducing its sulfur content, Reid vapor pressure, and olefin content as described herein, the olefin content of each grade of gasoline product can be reduced significantly for winter and summer grades and the total olefin content for the gasoline pool, such as measured on a monthly basis, may be reduced significantly, and may be around 3.0 vol % or less. The operating severity of LCN processing step can be adjusted to vary the gasoline pool olefins content.

1. A method for producing gasoline comprising:
separating a cracked naphtha feed into a light catalytic naphtha fraction and a heavy naphtha fraction; and
exposing the light catalytic naphtha fraction to a catalyst under effective conversion conditions to reduce sulfur content of the light catalytic naphtha fraction while also reducing a Reid vapor pressure and an olefin content of the light catalytic naphtha fraction, wherein the effective conversion conditions comprise a pressure of less than about 500 psig and a temperature of at least about 550° F. (288° C.).

2. The method of claim 1, further comprising blending the light catalytic naphtha fraction into one or more grades of gasoline product produced by a refinery, each of the one or more grades of gasoline product comprising gasoline boiling range hydrocarbons, and wherein a total olefin content for the gasoline pool in a month is about 3.0 vol % or less.

3. The method of claim 1, wherein the heavy naphtha fraction comprises about 90 wt % or more of the C9+ hydrocarbons in the cracked naphtha feed.

4. The method of claim 1, wherein the light catalytic naphtha fraction comprises C5 hydrocarbons from the cracked naphtha feed.

5. The method of claim 4, wherein the light catalytic naphtha fraction further comprises C6 hydrocarbons from the cracked naphtha feed.

6. The method of claim 5, wherein the light catalytic naphtha fraction further comprises C7 hydrocarbons from the cracked naphtha feed.

7. The method of claim 1, wherein the temperature is between about 700° F. and about 900° F.

8. The method of claim 7, wherein the temperature is between about 750° F. and about 850° F.

9. The method of claim 1, wherein the cracked naphtha feed comprises fluid catalytic cracking naphtha, coker naphtha, steam cracker naphtha or any combination thereof.

10. The method of claim 1, wherein the cracked naphtha feed comprises pyrolysis gasoline.

11. The method of claim 1, wherein the cracked naphtha feed comprises cracked naphtha feed comprises a reformate comprising benzene.

12. The method of claim 1, wherein the step of exposing the light catalytic naphtha fraction to the catalyst comprises converting about 90 wt % or more of thiophene in the light catalytic naphtha fraction.

13. The method of claim 1, wherein the step of exposing the light catalytic naphtha fraction to the catalyst comprises converting about 90 wt % or more of mercaptan in the light catalytic naphtha fraction.

14. The method of claim 1, further comprising cofeeding an-olefin containing stream with the light catalytic naphtha fraction to a reactor containing the catalyst.

15. The method of claim 1, wherein the catalyst comprises a zeolite or a SAPO.

16. The method of claim 14, wherein the catalyst comprises ZSM-5.

17. The method of claim 1, further comprising hydrotreating or selectively hydrotreating the heaving naphtha fraction.

18. The method of claim 1, wherein a majority of olefins in the light catalytic naphtha fraction are converted when exposing the light catalytic naphtha fraction the catalyst under the effective conversion conditions.

19. The method of claim 1, wherein the Reid vapor pressure of the light catalytic naphtha fraction is reduced by at least 1 psi when exposing the light catalytic naphtha fraction the catalyst under the effective conversion conditions.

20. A gasoline pool for a refinery comprising: one or more grades of gasoline product produced by the refinery, each of the one or more grades of gasoline product comprising gasoline boiling range hydrocarbons, and wherein a total olefin content for the gasoline pool in a month is about 3.0 vol % or less.
